(19) United States
(12) Patent Application Publication
(10) Pub. No.: US 2025/0043118 A1
(43) Pub. Date: Feb. 6, 2025

(54) RUBBER COMPOSITION COMPRISING A HIGHLY SATURATED DIENE ELASTOMER

(71) Applicant: COMPAGNIE GENERALE DES ETABLISSEMENTS MICHELIN, Clermont-Ferrand (FR)

(72) Inventors: JOSE-CARLOS ARAUJO DA SILVA, Clermont-Ferrand (FR); BENJAMIN GORNARD, Clermont-Ferrand (FR); FRANCOIS LALLET, Clermont-Ferrand (FR)

(21) Appl. No.: 18/719,978

(22) PCT Filed: Dec. 13, 2022
(86) PCT No.: PCT/EP2022/085690

§ 371 Date: Jun. 14, 2024

(30) Foreign Application Priority Data
Dec. 16, 2021 (FR) FR2113625

(51) Int. Cl. C08L 23/08; B60C 1/00; C08K 3/04; C08K 3/36

(52) U.S. Cl. CPC C08L 23/083; B60C 1/0016; C08K 3/04; C08K 3/36; C08L 2207/324

(57) ABSTRACT

A rubber composition is based on at least an elastomer matrix predominantly comprising a highly saturated diene elastomer, a reinforcing filler, a vulcanization system, and a plasticizing system comprising a hydrocarbon resin having a Tg between −40° C. and 20° C. and a number-average molar mass (Mn) of less than or equal to 800 g/mol, the highly saturated diene elastomer being a copolymer of ethylene and of at least one 1,3-diene in which the ethylene units represent at least 50 mol % of the monomer units of the copolymer.

### TECHNICAL FIELD

The field of the present invention is that of rubber compositions based on highly saturated diene elastomer, which are intended to be used in a tyre, notably in its tread.

### PRIOR ART

The use of highly saturated diene elastomer is known in the prior art. For example, the applicant has described copolymers of ethylene and 1,3-butadiene and the use thereof in a tyre tread in document WO 2014/114607 A1. This document indicates that the use of these copolymers results in good wear resistance and rolling resistance properties of the tyre.

In the field of plasticizers and in particular plasticizing resins, certain documents by the applicant mention the use of low-Tg resins as plasticizers in rubber compositions for tyres based on an SBR elastomer in order to shift the existing balance between various types of performance desired for the tyre, including rolling resistance, dry grip and wet grip, and to optimize the hardness of cured rubber compositions at the same time as their viscosity in the uncured state. Mention may thus be made of documents WO 2015/124684 A1 and WO 2015/124681 A1.

However, manufacturers are always looking for solutions to improve tyre performance or shift the balance between types of performance. In the field discussed above of tyres comprising a highly saturated diene elastomer in the tread, there is still a need for rubber compositions which give the tyre improved rolling resistance properties without adversely affecting the other properties such as grip on the ground.

### SUMMARY OF THE INVENTION

The applicant has found a rubber composition which makes it possible to meet this need in the field of application of highly saturated diene elastomers in rubber compositions for tyres and in particular for the tread. Very particularly, the applicant has found a rubber composition which combines the use of a highly saturated diene elastomer with the use of a low-Tg resin, and which gives the tyre, against all expectations, good rolling resistance properties and a shifted compromise of rolling resistance/wet grip properties, in particular with improved wet grip properties compared to the combined use of an SBR diene elastomer with a low-Tg resin.

Thus, a first subject of the invention is a rubber composition based on at least:
an elastomeric matrix predominantly comprising a highly saturated diene elastomer,
a reinforcing filler,
a vulcanization system, and
a plasticizing system comprising a low-Tg resin.

Another subject of the invention is a pneumatic or non-pneumatic tyre which comprises a rubber composition in accordance with the invention, preferably in its tread.

### SUMMARY OF THE INVENTION

The invention, which is described in greater detail below, has as subject at least one of the embodiments listed in the following points:

### 1. Rubber Composition Based on at Least:

an elastomer matrix predominantly comprising a highly saturated diene elastomer, which highly saturated diene elastomer is a copolymer of ethylene and at least one 1,3-diene in which the ethylene units represent at least 50 mol % of the monomer units of the copolymer,
a reinforcing filler,
a vulcanization system, and
a plasticizing system comprising a low-Tg (glass transition temperature) hydrocarbon resin, which is optionally hydrogenated, having a Tg of between −40° C. and 20° C. and a number-average molar mass (Mn) of less than 800 g/mol.

2. Rubber composition according to embodiment 1, in which the ethylene units represent at least 50 mol % and at most 95 mol % of the monomer units of the highly saturated diene elastomer.

3. Rubber composition according to either one of the preceding embodiments, in which the ethylene units represent at least 65 mol % of the monomer units of thehighly saturated diene copolymer, preferably from 65 mol % to 90 mol % of the monomer units of the copolymer.

4. Rubber composition according to any one of the preceding embodiments, in which the at least one 1,3-diene is 1,3-butadiene, isoprene, myrcene or farnesene, preferably 1,3-butadiene.

5. Rubber composition according to any one of the preceding embodiments, in which the copolymer of ethylene and at least one 1,3-diene is a copolymer of ethylene and 1,3-butadiene.

6. Rubber composition according to any one of the preceding embodiments, in which the copolymer is a random copolymer.

7. Rubber composition according to any one of the preceding embodiments, in which the content of highly saturated diene elastomer in the rubber composition varies within a range extending from 60 to 100 phr, preferably from 80 to 100 phr and very preferentially from 90 to 100 phr.

8. Composition according to any one of the preceding embodiments, in which the content of low-Tg hydrocarbon resin is within a range extending from 20 to 120 phr, preferably from 40 to 110 phr.

9. Composition according to any one of the preceding embodiments, in which the low-Tg hydrocarbon resin is a predominantly styrene, and highly hydrogenated, resin.

10. Composition according to any one of the preceding embodiments, in which the low-Tg hydrocarbon resin has a Tg of between −40° C. and 0° C., more preferentially between −40° C. and −20° C.

11. Composition according to any one of the preceding embodiments, in which the low-Tg hydrocarbon resin has a Tg ranging from −35° C. to −25° C.

12. Composition according to any one of the preceding embodiments, in which the low-Tg hydrocarbon resin has a number-average molar mass of greater than or equal to 250 g/mol and less than 600 g/mol.

13. Composition according to any one of the preceding embodiments, in which the low-Tg hydrocarbon resin has a value of the polydispersity index (PDI=Mw/Mn) of at most 1.60.

14. Composition according to any one of the preceding embodiments, in which the low-Tg hydrocarbon resin has an aliphatic proton content measured by NMR (standardized method) of at least 90%, preferably of at least 95%.

15. Composition according to any one of the preceding embodiments, in which the low-Tg hydrocarbon resin has an aromatic proton content of less than 5%.

16. Composition according to the preceding embodiment, in which the low-Tg hydrocarbon resin has an aromatic proton content ranging from 0% to 4%, preferably from 0% to 2%.

17. Composition according to any one of the preceding embodiments, in which the low-Tg hydrocarbon resin has an ethylenic proton content of less than 5%.

18. Composition according to any one of the preceding embodiments, in which the low-Tg hydrocarbon resin has an ethylenic proton content of less than or equal to 3%.

19. Composition according to any one of the preceding embodiments, in which the low-Tg hydrocarbon resin mentioned has a softening point within a range extending from +10° C. to 70° C., preferentially from 10° C. to 40° C., more preferentially from 10° C. to 30° C., preferably from 15° C. to 25° C.

20. Composition according to any one of the preceding embodiments, in which the plasticizing system further comprises at least one plasticizing oil or at least one hydrocarbon resin with a Tg above 20° C., or else at least one plasticizing oil and one hydrocarbon resin with a Tg above 20° C.

21. Composition according to any one of the preceding embodiments, in which the total content of plasticizers constituting the plasticizing system is greater than or equal to 25 phr, preferably within a range extending from 40 to 110 phr.

22. Composition according to the preceding embodiment, in which the total content of plasticizers constituting the plasticizing system is within a range extending from 40 to 100 phr, preferably from 40 to 90 phr.

23. Composition according to any one of the preceding embodiments, in which the reinforcing filler comprises at least a silica, a carbon black or a mixture of silica and carbon black.

24. Composition according to any one of the preceding embodiments, in which the reinforcing filler comprises a silica as the predominant reinforcing filler.

25. Composition according to any one of the preceding embodiments, in which the content of reinforcing filler is within a range extending from 5 to 200 phr, preferably from 40 to 160 phr.

26. Composition according to any one of the preceding embodiments, in which the content of silica is within a range extending from 50 to 160 phr.

27. Pneumatic or non-pneumatic tyre comprising a composition according to any one of the preceding embodiments.

28. Pneumatic or non-pneumatic tyre according to the preceding embodiment comprising a composition according to any one of embodiments 1 to 26 in all or part of its tread.

### Definitions

The expression “composition based on” should be understood as meaning a composition including the mixture and/or the product of the in situ reaction of the various constituents used, some of these constituents being able to react and/or being intended to react with each other, at least partially, during the various phases of manufacture of the composition; it thus being possible for the composition to be in the completely or partially crosslinked state or in the non-crosslinked state.

For the purposes of the present invention, the expression “part by weight per hundred parts by weight of elastomer” (or phr) should be understood as meaning the part by mass per hundred parts by mass of elastomer.

In the present text, unless expressly indicated otherwise, all the percentages (%) indicated are mass percentages (%).

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b). In the present document, when an interval of values is denoted by the expression “from a to b”, the interval represented by the expression “between a and b” is also and preferentially denoted.

In the present application, the expression “all of the monomer units of the elastomer” or “the total amount of the monomer units of the elastomer” means all the constituent repeating units of the elastomer which result from the insertion of the monomers into the elastomer chain by polymerization. Unless otherwise indicated, the contents of a monomer unit or repeating unit in the highly saturated diene elastomer are given as molar percentages calculated on the basis of all of the monomer units of the elastomer.

When reference is made to a “predominant” compound, this is understood to mean, for the purposes of the present invention, that this compound is predominant among the compounds of the same type in the composition, that is to say that it is the one which represents the greatest amount by weight among the compounds of the same type. Thus, for example, a predominant elastomer is the elastomer representing the greatest weight with respect to the total weight of the elastomers in the composition. In the same way, a “predominant” filler is that representing the greatest weight among the fillers of the composition. By way of example, in a system comprising only one elastomer, the latter is predominant for the purposes of the present invention, and in a system comprising two elastomers, the predominant elastomer represents more than half of the weight of the elastomers. In contrast, a “minor” compound is a compound which does not represent the greatest fraction by weight among the compounds of the same type. Preferably, “predominant” is understood to mean a weight proportion of more than 50%; when the compound represents 100% by weight, it is also referred to as “predominant”.

The compounds mentioned in the description may be of fossil origin or may be biobased. In the latter case, they may be partially or completely derived from biomass or may be obtained from renewable starting materials derived from biomass. In the same way, the compounds mentioned can also originate from the recycling of pre-used materials, that is to say that they can, partially or completely, result from a recycling process, or else be obtained from starting materials which themselves result from a recycling process. This notably relates to polymers, plasticizers, fillers, etc.

Unless otherwise indicated, as is the case in the examples presented below, the glass transition temperature (Tg) values described herein are measured in a known manner by DSC (differential scanning calorimetry) according to the standard ASTM D3418 (1999).

### DETAILED DESCRIPTION OF THE INVENTION

1 Elastomer matrix

The term “elastomer matrix” means all the elastomers of the composition.

According to the invention, the elastomer matrix predominantly comprises at least one highly saturated diene elastomer, namely a copolymer containing ethylene units and diene units (referred to hereinbelow as “the copolymer”).

The highly saturated diene elastomer that is useful for the purposes of the invention is a copolymer, preferably a random copolymer, which comprises ethylene units resulting from the polymerization of ethylene. In a known manner, the term “ethylene unit” refers to the —(CH₂—CH₂)— unit resulting from the insertion of ethylene into the elastomer chain. The highly saturated diene elastomer is rich in ethylene units, since the ethylene units represent at least 50 mol % of all of the monomer units of the elastomer, and at most 95 mol %.

Preferably, the highly saturated diene elastomer comprises at least 65 mol % of ethylene units. In other words, the ethylene units preferentially represent at least 65 mol % of all of the monomer units of the highly saturated diene elastomer. More preferentially, the highly saturated diene elastomer comprises from 65 mol % to 90 mol % of ethylene units, the molar percentage being calculated on the basis of all of the monomer units of the highly saturated diene elastomer.

Since the highly saturated diene elastomer is a copolymer of ethylene and of at least one 1,3-diene, it also comprises 1,3-diene units resulting from the polymerization of at least one 1,3-diene. In a known manner, the expression “1.3-diene unit” refers to the units resulting from the insertion of the 1,3-diene.

The 1,3-diene units are those, for example, of a 1,3-diene containing 4 to 24 carbon atoms.

The following are suitable in particular as 1,3-diene: butadiene, isoprene, 2,3-di(C₁-C₅ alkyl)-1,3-butadienes, such as for example 2,3-dimethyl-1,3-butadiene, 2,3-diethyl-1,3-butadiene, 2-methyl-3-ethyl-1,3-butadiene or 2-methyl-3-isopropyl-1,3-butadiene, aryl-1,3-butadienes such as phenyl-1,3-pentadiene, or 1,3-pentadiene. The following are also suitable as 1,3-diene: a 1,3-diene of formula CH₂═CR—CH═CH₂, in which R represents a hydrocarbon chain containing 3 to 20 carbon atoms, such as for example a linear monoterpene (C₁₀H₁₆), for instance myrcene, a linear sesquiterpene (C₁₅H₂₄), for instance farnesene, etc.

The highly saturated diene elastomer is preferably a copolymer of ethylene and at least one 1,3-diene from among 1,3-butadiene, isoprene, myrcene and farnesene.

Preferably, the at least one 1,3-diene is 1,3-butadiene or isoprene, more preferentially 1,3-butadiene, in which case the highly saturated diene elastomer is a copolymer of ethylene and 1,3-butadiene, preferably a random copolymer.

The highly saturated diene elastomer that is useful for the purposes of the invention may be obtained according to various synthetic methods known to those skilled in the art, notably as a function of the targeted microstructure of the highly saturated diene elastomer. Generally, it may be prepared by copolymerization at least of a 1,3-diene, preferably 1,3-butadiene, and of ethylene and according to known synthetic methods, in particular in the presence of a catalytic system comprising a metallocene complex. Mention may be made, in this respect, of catalytic systems based on metallocene complexes, which catalytic systems are described in documents EP 1 092 731, WO 2004/035639, WO 2007/054223 and WO 2007/054224, and also WO 2020/070442, WO 2020/070443 and WO 2020/074804 in the name of the applicant. The highly saturated diene elastomer, including the case when it is random, may also be prepared via a process using a catalytic system of preformed type such as those described in WO 2017/093654 A1, WO 2018/020122 A1 and WO 2018/020123 A1. The highly saturated diene elastomer is random according to one embodiment of the invention.

The highly saturated diene elastomer that is useful for the purposes of the invention may consist of a mixture of highly saturated diene elastomers which differ from each other in their microstructures or in their macrostructures.

According to the invention, the content of the highly saturated diene elastomer in the rubber composition is preferably at least 50 parts by weight per hundred parts of elastomer of the rubber composition (phr). More preferably, the content of highly saturated diene elastomer in the rubber composition varies in a range extending from 60 to 100 phr, preferentially 80 to 100 phr. More preferentially, it varies in a range extending from 90 to 100 phr.

In addition, the elastomer matrix of the composition of the invention may comprise at least one other elastomer, in a minor amount. Particularly the diene elastomers known to those skilled in the art for their use in the field of tyres, such as a polybutadiene (abbreviated to “BR”), a synthetic polyisoprene (IR), natural rubber (NR), a butadiene copolymer such as a butadiene-styrene copolymer (SBR), an isoprene copolymers and mixtures of these elastomers.

### 2 Specific Plasticizer

### Low-Tg Resin

The composition of the invention comprises at least one hydrocarbon resin having a Tg in a range extending from −40° C. to 20° C., that is to say viscous at 20° C., referred to as a “low-Tg” resin, and a number-average molar mass (Mn) of less than or equal to 800 g/mol.

Preferably, the low-Tg plasticizing hydrocarbon resin exhibits at least any one of the following characteristics:
a Tg of between −40° C. and 0° C., more preferentially between −40° C. and −20° C. and more preferentially still between −35° C. and −25° C.;
a number-average molar mass (Mn) of greater than or equal to 150 g/mol, preferably greater than or equal to 250 g/mol and less than or equal to 600 g/mol, more preferentially greater than or equal to 250 g/mol and less than or equal to 500 g/mol;
a value of the polydispersity index (PDI=Mw/Mn) of at most 1.6, preferentially of at most 1.4.

Also preferably, the low-Tg plasticizing hydrocarbon resin has a softening point within a range extending from 10° C. to 70° C., preferentially from 10° C. to 40° C., more preferentially from 10° C. to 30° C., preferably from 15° C. to 25° C.

More preferably, this low-Tg plasticizing hydrocarbon resin exhibits all of the preferred characteristics above.

The softening point is measured according to the standard ISO 4625 (“ring and ball” method). The Tg is measured according to the standard ASTM D3418 (1999). The macrostructure (Mw, Mn and PDI) of the hydrocarbon resin is determined by size exclusion chromatography (SEC); solvent tetrahydrofuran; temperature 35° C.; concentration 1 g/l; flow rate 1 ml/min; solution filtered through a filter with a porosity of 0.45 μm before injection; Moore calibration with polystyrene standards; set of 3 Waters columns in series (Styragel HR4E, HR1 and HR0.5); detection by differential refractometer (Waters 2410) and its associated operating software (Waters Empower).

The hydrocarbon resins according to the invention may be aliphatic, or aromatic, or else of mixed aliphatic/aromatic type, i.e. the hydrocarbon resins according to the invention comprise aliphatic constitutional units, aromatic constitutional units, or else aliphatic constitutional units and aromatic constitutional units. They may be natural or synthetic and may or may not be petroleum-based (if such is the case, they are also known as petroleum resins).

The hydrocarbon resins according to the invention may be derived from the polymerization of one or more monomers from among aromatic monomers and aliphatic monomers. The hydrocarbon resins may have undergone partial or complete hydrogenation on conclusion of the polymerization.

According to one embodiment, the low-Tg plasticizing hydrocarbon resin according to the invention is selected from the group consisting of cyclopentadiene (abbreviated to CPD) or dicyclopentadiene (abbreviated to DCPD) homopolymer or copolymer resins, terpene homopolymer or copolymer resins, terpene/phenol homopolymer or copolymer resins, C₅ fraction homopolymer or copolymer resins, styrene homopolymer and copolymer resins, C₉ fraction (or more generally C₈ to C₁₀ fraction) homopolymer or copolymer resins, and the mixtures of these resins. The term “terpene” groups together here, in a known manner, α-pinene, β-pinene and limonene monomers.

According to a preferred embodiment, the hydrocarbon resin that is useful for the purposes of the invention is a hydrocarbon resin based on one or more aromatic monomers. Aromatic monomers that are suitable include, for example: styrene, α-methylstyrene, ortho-, meta- or para-methylstyrene, vinyltoluene, para-(tert-butyl)styrene, methoxystyrenes, chlorostyrenes, vinylmesitylene, divinylbenzene, vinylnaphthalene or any vinylaromatic monomer resulting from a C₉ fraction (or more generally from a C₈ to C₁₀ fraction). Preferably, the vinylaromatic monomer is styrene or a vinylaromatic monomer resulting from a C₉ fraction (or more generally from a C₈ to C₁₀ fraction). According to this embodiment, the hydrocarbon resin may be partially or completely hydrogenated, forming an aliphatic/aromatic or aliphatic hydrocarbon resin.

According to an even more preferred embodiment, the hydrocarbon resin that is useful for the purposes of the invention is a resin that is predominantly based on styrene and is hydrogenated. Such a resin is, for example, a hydrogenated resin based on styrene, as the predominant monomer, and on vinyltoluene.

According to one embodiment of the invention, the low-Tg hydrocarbon resin has an aliphatic proton content of at least 90%, preferably of at least 95%.

According to a preferred embodiment, the hydrocarbon resin that is useful for the purposes of the invention has an aromatic proton content of less than 5%, preferably within a range extending from 0% to 4%, preferably from 0% to 2%.

According to a preferential embodiment, the hydrocarbon resin that is useful for the purposes of the invention has an ethylenic proton content of less than 5%, preferably within a range extending from 0% to 3%.

The aromatic proton content (% HA) and the ethylenic proton content (% HE) are measured by ¹H NMR. This determination is performed with respect to all of the signals detected. Thus, the results obtained are expressed as percentage of the peak area.

The samples are dissolved in deuterated chloroform (CDCl₃) in a proportion of approximately 10 mg of resin in approximately 1 ml of solvent. The spectra are acquired on a Bruker Avance 500 MHz spectrometer equipped with a Bruker “broad band” BBO z-grad 5 mm probe. The ¹H NMR experiment uses a single 30° pulse sequence and a repetition time of 5 seconds between each acquisition. 64 accumulations are performed at room temperature. The chemical shifts are calibrated relative to the protonated impurity of the deuterated chloroform; δ ppm ¹H at 7.20 ppm. The ¹H NMR signals of the aromatic protons are located between 8.5 ppm and 6.2 ppm. The ethylenic protons for their part give rise to signals between 6.2 ppm and 4.5 ppm. Finally, the signals corresponding to the aliphatic protons are located between 4.5 ppm and 0 ppm. The areas of each category of protons are taken relative to the sum of these areas to thus give a distribution in terms of an area percentage for each category of protons.

Resins which can be used in the context of the invention are commercially available, for example sold by Cray Valley under the name Wingtack 10 (aliphatic resin with Mn=483 g/mol; Mw=595 g/mol; PDI=1.2; softening point=10° C.; Tg=−28° C.); or by Eastman under the name Regalrez 1018 (aliphatic resin with Mn=360 g/mol; Mw=464 g/mol; PDI=1.3; softening point=20° C.; Tg=−23° C.).

The content of low-Tg plasticizing hydrocarbon resin is greater than or equal to 20 phr, preferably within a range extending from 20 phr to 120 phr, preferentially from 40 to 110 phr, or else from 45 to 90 phr. This is because, below 20 phr of low-Tg resin, the composition might exhibit problems of high viscosity and thus of industrial processability.

The low-Tg plasticizing hydrocarbon resin may be a mixture of severallow-Tg plasticizing hydrocarbon resins as described above.

The plasticizing system according to the invention may comprise, in addition to the low-Tg plasticizing hydrocarbon resin, at least one plasticizing oil or at least one hydrocarbon resin with a Tg above 20° C., or else at least one plasticizing oil and one hydrocarbon resin with a Tg above 20° C. These plasticizers are well known to those skilled in the art and are commercially available.

The total amount of plasticizers (low-Tg plasticizing hydrocarbon resin, plasticizing oil, hydrocarbon resin with a Tg above 20° C.) constituting the plasticizing system is greater than or equal to 25 phr, preferably within a range extending from 40 to 110 phr. According to certain embodiments, the total content of plasticizers constituting the plasticizing system is within a range extending from 40 to 100 phr, preferably within a range extending from 40 to 90 phr.

### 3 Reinforcing Filler

The composition according to the invention comprises a reinforcing filler. Use may be made of any type of reinforcing filler known for its abilities to reinforce a rubber composition which can be used for the manufacture of tyres, for example an organic filler, such as carbon black, a reinforcing inorganic filler, such as silica or alumina, or also a blend of these two types of filler. More particularly, the reinforcing filler comprises at least a silica, a carbon black or a mixture of silica and carbon black.

All carbon blacks, notably “tyre-grade” blacks, are suitable as carbon blacks. Among the latter, mention will be made more particularly of the reinforcing carbon blacks of the 100, 200 or 300 series (ASTM grades), such as the N115, N134, N234, N326, N330, N339, N347 or N375 blacks, or else, depending on the applications targeted, blacks of higher series (for example N660, N683 or N772). The carbon blacks might, for example, be already incorporated in an isoprene elastomer in the form of a masterbatch (see, for example, Applications WO 97/36724 and WO 99/16600).

Mention may be made, as examples of organic fillers other than carbon blacks, of functionalized polyvinyl organic fillers, such as described in applications WO-A-2006/069792, WO-A-2006/069793, WO-A-2008/003434 and WO-A-2008/003435.

The composition can comprise one type of silica or a blend of several silicas. The silica used can be any reinforcing silica known to a person skilled in the art, in particular any precipitated or fumed silica exhibiting a BET specific surface area and also a CTAB specific surface area which are both less than 450 m²/g, preferably from 30 to 400 m²/g. Mention will be made, as highly dispersible precipitated silicas (“HDSs”), for example, of the Ultrasil 7000 and Ultrasil 7005 silicas from Degussa, the Zeosil 1165MP, 1135MP and 1115MP silicas from Solvay, the Hi-Sil EZ150G silica from PPG, the Zeopol 8715, 8745 and 8755 silicas from Huber, treated precipitated silicas, such as, for example, the silicas “doped” with aluminium described in application EP-A-0735088, or the silicas with a high specific surface area as described in application WO 03/16837.

The composition according to the invention may also optionally contain coupling agents, coupling activators, agents for covering the inorganic fillers or more generally processing aids that are capable, in a known manner, by means of improving the dispersion of the filler in the rubber matrix and of lowering the viscosity of the composition, of improving its ability to be processed in the uncured state, these agents being, for example, hydrolysable silanes such as alkylalkoxysilanes, polyols, fatty acids, polyethers, primary, secondary or tertiary amines, or hydroxylated or hydrolysable polyorganosiloxanes. Use may in particular be made of silane polysulfides, referred to as “symmetrical” or “asymmetrical” depending on their specific structure, such as described, for example, in applications WO 03/002648 (or US 2005/016651) and WO 03/002649 (or US 2005/016650).

In the rubber composition in accordance with the invention, the content of coupling agent is preferentially between 1 and 15 phr.

Those skilled in the art will understand that use might be made, as filler equivalent to silica described in the present section, of a reinforcing filler of another nature, in particular organic nature, provided that this reinforcing filler is covered with a layer of silica or else comprises, at its surface, functional sites, in particular hydroxyl sites, requiring the use of a coupling agent in order to establish the bond between the filler and the elastomer.

The physical state in which the reinforcing filler is provided is not important, whether in the form of a powder, of micropearls, of granules, of beads or any other appropriate densified form.

For the purposes of the invention, the content of total reinforcing filler (carbon black and/or reinforcing inorganic filler, such as silica) is from 5 to 200 phr, more preferably from 40 to 160 phr. Below 5 phr of filler, the composition might not be sufficiently reinforced, whereas, above 200 phr of filler, the composition might be less effective in terms of rolling resistance.

Preferably, use is made of silica as predominant filler, preferably in a content ranging from 50 to 160 phr, more preferentially from 60 to 150 phr, and optionally of carbon black. The carbon black, when it is present, is then used in a minor amount, preferably at a content within a range extending from 0.1 to 10 phr, more preferentially from 0.5 to 10 phr, in particular from 1 to 5 phr.

### 4 Crosslinking System

The crosslinking system may be any type of system known to those skilled in the art in the field of rubber compositions for tyres. It may notably be based on sulfur and/or on peroxide and/or on bismaleimides.

Preferentially, the crosslinking system is based on sulfur; it is then referred to as a vulcanization system. The sulfur can be provided in any form, in particular in the form of molecular sulfur or of a sulfur-donating agent. At least one vulcanization accelerator is also preferentially present, and, optionally, also preferentially, use may be made of various known vulcanization activators, such as zinc oxide, stearic acid or an equivalent compound, such as stearic acid salts, and salts of transition metals, guanidine derivatives (in particular diphenylguanidine), or else known vulcanization retarders.

The sulfur is used in a preferential content of between 0.2 phr and 10 phr, more preferentially between 0.3 and 5 phr. The vulcanization accelerator or mixture of vulcanization accelerators is used in a preferential content of between 0.5 and 10 phr, more preferentially between 0.5 and 5 phr.

Use may be made, as accelerator, of any compound that is capable of acting as an accelerator for the vulcanization of diene elastomers in the presence of sulfur, notably accelerators of the thiazole type, and also derivatives thereof, or accelerators of sulfenamide, thiuram, dithiocarbamate, dithiophosphate, thiourea and xanthate type. As examples of such accelerators, mention may notably be made of the following compounds: 2-mercaptobenzothiazyl disulfide (abbreviated as “MBTS”), N-cyclohexyl-2-benzothiazolesulfenamide (“CBS”), N,N-dicyclohexyl-2-benzothiazolesulfenamide (“DCBS”), N-(tert-butyl)-2-benzothiazolesulfenamide (“TBBS”), N-(tert-butyl)-2-benzothiazolesulfenimide (“TBSI”), tetrabenzylthiuram disulfide (“TBZTD”), zinc dibenzyldithiocarbamate (“ZBEC”) and mixtures of these compounds.

### 5 Possible Additives

The rubber compositions according to the invention may optionally also include all or some of the usual additives customarily used in elastomer compositions for tyres: pigments, protective agents such as anti-ozone waxes, chemical anti-ozonants, antioxidants, anti-fatigue agents, reinforcing resins (as described, for example, in application WO 02/10269).

It goes without saying that the invention relates to the rubber compositions described previously both in the “uncured” or non-crosslinked state (i.e., before curing) and in the “cured” or crosslinked, or else vulcanized, state (i.e., after crosslinking or vulcanization).

### 6 Preparation of the Rubber Composition

The composition in accordance with the invention can be manufactured in appropriate mixers using two successive preparation phases well known to those skilled in the art:
a first phase of thermomechanical working or kneading (known as the “non-productive” phase), that can be performed in a single thermomechanical step during which all the necessary constituents, notably the elastomeric matrix, the reinforcing filler and the various other optional additives, with the exception of the crosslinking system, are introduced into an appropriate mixer, such as a standard internal mixer (for example of Banbury type). The incorporation of the optional filler into the elastomer may be performed in one or more portions while thermomechanically kneading. In the case where the filler is already incorporated, totally or partly, in the elastomer in the form of a masterbatch, as is described, for example, in patent application WO 97/36724 or WO 99/16600, it is the masterbatch which is directly kneaded and, if appropriate, the other elastomers or fillers present in the composition which are not in the masterbatch form, and also the various other optional additives other than the crosslinking system, are incorporated. The non-productive phase may be performed at high temperature, up to a maximum temperature of between 110° C. and 200° C., preferably between 130° C. and 185° C., for a period of time generally of between 2 and 10 minutes.
a second phase of mechanical working (known as the “productive” phase), which is performed in an external mixer, such as an open mill, after cooling the mixture obtained during the first non-productive phase down to a lower temperature, typically below 120° C., for example between 40° C. and 100° C. The crosslinking system is then incorporated and the combined mixture is then mixed for a few minutes, for example between 5 and 15 min.

Such phases are well known to those skilled in the art.

The final composition thus obtained is then calendered, for example in the form of a sheet or of a slab, notably for laboratory characterization, or else is extruded (or co-extruded with another rubber composition) in the form of a rubber semi-finished product (or profiled element) which can be used, for example, as a tyre tread. These products may then be used for the manufacture of tyres, according to the techniques known to those skilled in the art.

The composition may be either in the uncured state (before crosslinking or vulcanization) or in the cured state (after crosslinking or vulcanization), or may be a semi-finished product which can be used in a tyre.

The crosslinking (or curing), or, where appropriate, the vulcanization, is performed in a known manner at a temperature generally between 130° C. and 200° C., for a sufficient time which may range, for example, between 5 and 90 min, notably depending on the curing temperature, the crosslinking system adopted and the crosslinking kinetics of the composition under consideration.

### 7 Tyre

Another subject of the present invention is a pneumatic or non-pneumatic tyre comprising a rubber composition according to the invention.

Preferably, the composition according to the invention is present at least in the tread of the pneumatic or non-pneumatic tyre according to the invention.

The abovementioned features of the present invention, and also others, will be understood more clearly on reading the following description of several implementation examples of the invention, which are given as nonlimiting illustrations.

### IMPLEMENTATIONAL EXAMPLES OF THE INVENTION

### 1—Tests and Measurements:

### 1-1 Determination of the Microstructure of Elastomers:

The microstructure of the elastomers is determined by ¹H NMR analysis, combined with ¹³C NMR analysis when the resolution of the ¹H NMR spectra does not enable assignment and quantification of all the species. The measurements are carried out using a Bruker 500 MHz NMR spectrometer at frequencies of 500.43 MHz for observing protons and 125.83 MHz for observing carbons.

For the insoluble elastomers which have the ability to swell in a solvent, a 4 mm z-grad HRMAS probe is used for proton and carbon observation in proton-decoupled mode. The spectra are acquired at spinning speeds of from 4000 Hz to 5000 Hz.

For the measurements on soluble elastomers, a liquid NMR probe is used for proton and carbon observation in proton-decoupled mode.

The insoluble samples are prepared in rotors filled with the material analysed and a deuterated solvent which makes swelling possible, in general deuterated chloroform (CDCl₃). The solvent used must always be deuterated and its chemical nature may be adapted by a person skilled in the art. The amounts of material used are adjusted so as to obtain spectra of sufficient sensitivity and resolution.

The soluble samples are dissolved in a deuterated solvent (approximately 25 mg of elastomer in 1 ml), in general deuterated chloroform (CDCl₃). The solvent or solvent blend used must always be deuterated and its chemical nature may be adapted by a person skilled in the art.

In both cases (soluble sample or swollen sample):

A 30° single pulse sequence is used for proton NMR. The spectral window is adjusted to observe all the resonance lines belonging to the molecules analysed. The accumulation number is adjusted in order to obtain a signal to noise ratio that is sufficient for the quantification of each unit. The recycle delay between each pulse is adapted to obtain a quantitative measurement.

For the carbon NMR, a single 30° pulse sequence is used with proton decoupling only during acquisition to avoid the nuclear Overhauser effects (NOE) and to remain quantitative. The spectral window is adjusted to observe all the resonance lines belonging to the molecules analyzed. The accumulation number is adjusted in order to obtain a signal to noise ratio that is sufficient for the quantification of each unit. The recycle delay between each pulse is adapted to obtain a quantitative measurement.

The NMR measurements are performed at 25° C.

### I-2 Measurement of the Dynamic Properties:

### Dynamic Properties

The dynamic properties G* and tan(δ)max are measured on a viscosity analyser (Metravib A4000) according to standard ASTM D5992-96. The response of a sample vulcanized composition (cylindrical test specimen with a thickness of 2 mm and a cross section of 79 mm²), subjected to a simple alternating sinusoidal shear stress, at a frequency of 10 Hz, is recorded. A temperature sweep is carried out from −80° C. to +100° C. with a gradient of +1.5° C./min, under a maximum stress of 0.7 MPa. The value of the tangent of the loss angle (tan(δ)) at 0° C. is then noted.

The following results are obtained from measurements using temperature sweeps at a given stress and strain sweeps, at a stress frequency of 10 Hz.

The strain hysteresis is determined by taking the maximum value of the loss angle on a return sweep from a strain sweep at 40° C. ranging from 0.01% to 100% peak-to-peak strain. This measurement is a descriptor of the hysteresis and therefore an indication of the rolling resistance property of the tyre. The value in base 100 is calculated according to the operation: (tan(δ) value at 40° C. of the control/tan(δ) value at 40° C. of the sample)*100. In this way, a lower value represents a reduction in the hysteresis performance (i.e. an increase in the hysteresis), while a higher value represents a better hysteresis performance (i.e. a lower hysteresis).

Similarly, the hysteresis at 0° C. is determined on a temperature sweep as defined above. This measurement is a descriptor of the hysteresis at low temperature and therefore an indication of the wet grip property. The value in base 100 is calculated according to the operation: (tan(δ) value at 0° C. of the sample/tan(δ) value at 0° C. of the control)*100. In this way, a lower value represents a reduction in the hysteresis performance (i.e. a reduction in wet grip), while a higher value represents a better hysteresis performance (i.e. a better wet grip performance).

### 2—Preparation of the Rubber Compositions:

The Rubber Compositions, the Details of the Formulation of which are Given in Table 1, were Prepared in the Following Manner:

The elastomer is introduced into an internal mixer (final degree of filling: approximately 70% by volume), the initial vessel temperature of which is approximately 90° C. When the temperature reaches 100° C., half of the silica and of the resin, and also the carbon black and the coupling agent, are introduced The other half of the silica and of the resin, the oil and also the various other ingredients, with the exception of sulfur and vulcanization accelerators, are introduced at 120° C. Thermomechanical working (non-productive phase) is then performed in one step, which lasts in total around 3 to 4 minutes, until a maximum “dropping” temperature of 160° C. is reached. The mixture thus obtained is recovered, cooled and the sulfur and vulcanization accelerators are then incorporated on a mixer (homofinisher) at 30° C., the whole being mixed (productive phase) for an appropriate time (for example about 10 minutes).

The compositions thus obtained are subsequently calendered, either in the form of slabs (thickness of 2 to 3 mm) or of thin sheets of rubber, for measurement of their physical or mechanical properties, or extruded in the form of a tyre tread.

### 3—Preparation of the Elastomer

The elastomer (EBR) is prepared according to the following procedure:

The cocatalyst, the butyloctylmagnesium (BOMAG) (0.00021 mol/l) and then the metallocene [{Me₂SiFlu₂Nd(μ-BH₄)₂Li(THF)}₂](0.07 mol/l) are added to a reactor containing methylcyclohexane, the Flu symbol representing the C₁₃H₈ group. The alkylation time is 10 minutes, the reaction temperature is 20° C. Then, the monomers in the form of a gas mixture of ethylene/1,3-butadiene molar composition: 80/20 are added continuously. The polymerization is carried out under conditions of constant temperature and pressure of 80° C. and 8 bar. The polymerization reaction is stopped by cooling, degassing the reactor and adding ethanol. An antioxidant is added to the polymer solution. The copolymer is recovered by drying in a vacuum oven to constant mass.

TABLE 1

| Components | C1 | C2 | C3 | C4 | C5 | C6 | C7 |
|---|---|---|---|---|---|---|---|
| EBR (1a) | 100.0 | 100.0 | 100.0 | 100.0 | | | |
| SBR (1b) | | | | | 100.0 | 100.0 | 100.0 |
| Black (2) | 3.0 | 3.0 | 3.0 | 3.0 | 3.0 | 3.0 | 3.0 |
| Silica (3) | 85.9 | 85.9 | 85.9 | 85.9 | 85.9 | 85.9 | 85.9 |
| Liquid silane (4) | 6.9 | 6.9 | 6.9 | 6.9 | 6.9 | 6.9 | 6.9 |
| DPG (5) | 1.7 | 1.7 | 1.7 | 1.7 | 1.7 | 1.7 | 1.7 |
| Resin | | | | 72.4 | 72.4 | | |
| Resin 1 (8) | 72.4 | | | | | 72.4 | |
| Resin 2 (9) | | 72.4 | | | | | 72.4 |
| Resin 3 (10) | | | 72.4 | | | | |
| Ozone wax (11) | 2.0 | 2.0 | 2.0 | 2.0 | 2.0 | 2.0 | 2.0 |
| 6-PPD (12) | 2.0 | 2.0 | 2.0 | 2.0 | 2.0 | 2.0 | 2.0 |
| SAD (13) | 2.0 | 2.0 | 2.0 | 2.0 | 2.0 | 2.0 | 2.0 |
| ZnO (14) | 0.9 | 0.9 | 0.9 | 0.9 | 0.9 | 0.9 | 0.9 |
| CBS (15) | 2.0 | 2.0 | 2.0 | 2.0 | 2.0 | 2.0 | 2.0 |
| Sulfur (16) | 1.0 | 1.0 | 1.0 | 1.0 | 1.0 | 1.0 | 1.0 |

```
1. Elastomer
  a. EBR with Mooney ML (1 + 4) at 100° C. = 80, with an ethylene content of 80 mol % and with Tg = −41° C.
  b. SBR containing 27% by weight of styrene and 24 mol % relative to the diene part of 1,2-butadiene units, bearing an Si-OH function at the chain end, and with Tg = −48° C.
2. ASTM N234 black from CABOT
3. 160MP silica from Solvay
4. Liquid silane Si69
5. Diphenylguanidine
6. MES oil
7. Escorez 5000 series resin from Exxon Mobil (Tg = 52° C.)
8. Wingtack 10 resin
9. Regalrez 1018 resin
10. Piccotac 1020-E resin
11. Ozone wax C32ST (WAX7132)
12. Santoflex 6PPD from FLEXSYS
13. Stearic acid
14. Zinc oxide
15. Cyclohexyl-benzothiazole sulfenamide (CBS) accelerator from Akrochem
16. Soluble sulfur
```

The characteristics of the resins, ingredients 8 to 10 are summed up in Table 2.

TABLE 2

| | | Commercial | Tg | | | | | | |
|---|---|---|---|---|---|---|---|---|---|
| Resin | Supplier | name | (° C.) | Arom. | Ethyl. | Aliph. | Mn | Mw | PDI |
| 1 | Cray Valley | Wingtack 10 | −28 | <0.1% | 3% | 97% | 483 | 595 | 1.23 |
| 2 | Eastman | REGALREZ 1018 | −23 | 2% | 0% | 98% | 364 | 460 | 1.26 |
| 3 | Eastman | Piccotac 1020-E | −30 | <0.1% | 2% | 98% | 943 | 1632 | 1.76 |

### 4— Results:

The results appear in Table 3.

TABLE 3

| | | | | | | |
|---|---|---|---|---|---|---|
| C1 | C2 | C3 | C4 | C5 | C6 | C7 |
| (invention) | (invention) | (control) | (control) | (control) | (control) | (control) |

Summary of elastomer and resin components

| | | | | | | | |
|---|---|---|---|---|---|---|---|
| EBR (1a) | 100.0 | 100.0 | 100.0 | 100.0 | | | |
| SBR (1b) | | | | | 100.0 | 100.0 | 100.0 |
| Resin (7) | | | | 72.4 | 72.4 | | |
| Resin 1 (8) | 72.4 | | | | | 72.4 | |
| Resin 2 (9) | | 72.4 | | | | | 72.4 |
| Resin 3 (10) | | | 72.4 | | | | |

Results

| | | | | | | | |
|---|---|---|---|---|---|---|---|
| Base 100 tan(δ) at 40° C. | 139 | 144 | 118 | 100 | 100 | 140 | 147 |
| Base 100 tan(δ) at 0° C. | 64 | 76 | 70 | 100 | 100 | 41 | 52 |

The results show that the composition according to the invention makes it possible, against all expectations, to greatly improve the hysteresis performance (rolling resistance) without excessively degrading the wet grip when the elastomer matrix is based on an EBR (comparison of C4 relative to C1 and C2). The wet grip performance is further degraded for compositions in which the elastomer matrix is based on SBR (comparison of C5 relative to C6 and C7, and also C1 and C2 versus C4, compared to C6 and C7 versus C5 respectively) for the SBR of Tg=−48° C.

The results also show that when the low-Tg resin does not exhibit all the required characteristics, particularly in terms of Mn (resin 3), when the elastomer matrix is based on an EBR, the improvement in hysteresis performance is lower and the wet grip/hysteresis compromise is degraded compared to a composition comprising a low-Tg resin in accordance with the invention and an elastomer matrix based on an EBR (comparison of C3 relative to C1 and C2).

1.-15. (canceled)

16. A rubber composition based on at least:
an elastomer matrix predominantly comprising a highly saturated diene elastomer, which highly saturated diene elastomer is a copolymer of ethylene and at least one 1,3-diene in which ethylene units represent at least 50 mol % of monomer units of the copolymer;
a reinforcing filler;
a vulcanization system; and
a plasticizing system comprising a low-Tg hydrocarbon resin, which is optionally hydrogenated, having a Tg of between −40° C. and 20° C. and a number-average molar mass Mn of less than or equal to 800 g/mol.

17. The rubber composition according to claim 16, wherein the ethylene units represent at least 50 mol % and at most 95 mol % of the monomer units of the highly saturated diene elastomer.

18. The rubber composition according to claim 16, wherein the at least one 1,3-diene is 1,3-butadiene, isoprene, myrcene or farnesene.

19. The rubber composition according to claim 16, wherein the copolymer of ethylene and at least one 1,3-diene is a copolymer of ethylene and 1,3-butadiene.

20. The rubber composition according to claim 16, wherein a content of highly saturated diene elastomer varies within a range extending from 60 to 100 phr.

21. The rubber composition according to claim 16, wherein a content of low-Tg hydrocarbon resin is within a range extending from 20 to 120 phr.

22. The rubber composition according to claim 16, wherein the low-Tg hydrocarbon resin has a Tg of between −40° C. and 0° C.

23. The rubber composition according to claim 16, wherein the low-Tg hydrocarbon resin has a number-average molar mass of greater than or equal to 250 g/mol and less than 600 g/mol.

24. The rubber composition according to claim 16, wherein the low-Tg hydrocarbon resin has a value of a polydispersity index (PDI=Mw/Mn) of at most 1.60.

25. The rubber composition according to claim 16, wherein the low-Tg hydrocarbon resin has an aliphatic proton content measured by NMR of at least 90%.

26. The rubber composition according to claim 16, wherein the low-Tg hydrocarbon resin has an aromatic proton content of less than 5%.

27. The rubber composition according to claim 16, wherein the low-Tg hydrocarbon resin is a predominantly styrene, and hydrogenated, resin.

28. The rubber composition according to claim 16, wherein the reinforcing filler comprises a silica as a predominant reinforcing filler.

29. The rubber composition according to claim 16, wherein a content of silica is within a range extending from 50 to 160 phr.

30. A pneumatic or non-pneumatic tire comprising the rubber composition according to claim 15.
